(19) United States
(12) Patent Application Publication
(10) Pub. No.: US 2025/0103956 A1
(43) Pub. Date: Mar. 27, 2025

(54) SYSTEMS AND METHODS FOR SPARSE DATA MACHINE LEARNING

(71) Applicant: Walmart Apollo, LLC, Bentonville, AR (US)

(72) Inventors: Cheng Chen, Fremont, CA (US); Shihui Jia, Cupertino, CA (US); Hui-Min Chen, Pleasanton, CA (US)

(21) Appl. No.: 18/731,902

(22) Filed: Jun. 3, 2024

Related U.S. Application Data
(60) Provisional application No. 63/585,527, filed on Sep. 26, 2023.

(51) Int. Cl. G06N 20/00

(52) U.S. Cl. CPC G06N 20/00

(57) ABSTRACT

Systems and methods for generating training datasets for use in machine learning are disclosed. A plurality of data records are received. Each record in the plurality of records includes a set of features. A first reduced dimension feature set is generated by applying a linear dimension reduction process to the set of features and a second reduced dimension feature set is generated by applying a non-linear dimension reduction process to the first reduced dimension feature set. The set of records is clustered based on the second reduced dimension feature set and a training dataset is generated by labeling each record in the plurality of records based on a cluster associated with each record. A machine learning model is trained by applying a supervised training process based on the training dataset.

### CROSS-REFERENCE TO RELATED APPLICATIONS

This application claims benefit under 35 U.S.C. § 119(e) to U.S. Provisional Appl. Ser. No. 63/585,527, filed 26 Sep. 2023, entitled “Systems and Methods for Sparse Data Machine Learning,” the disclosure of which is incorporated herein by reference in its entirety.

### TECHNICAL FIELD

This application relates generally to machine learning training processes, and more particularly, to semi-supervised machine learning processes.

### BACKGROUND

Data tagging enables machine learning modeling and strategy development for different classes of data. For example, fraud tagging enables machine learning model training for detecting different classes of frauds. However, data tagging is a labor and time intensive process that requires detailed expertise. Even when time and resources may be devoted to data tagging, a specific data class may have a limited number of training examples.

Some current training systems utilize training datasets including multiple classes of data to be identified. For example, a training dataset may include a first class, a second class, and a third class. These current systems may not provide adequate detection of certain classes, as the use of training datasets including multiple classes can result in low performance for a specific class having low representation within the training dataset.

### SUMMARY

In various embodiments, a system comprising a non-transitory memory and a processor communicatively coupled to the non-transitory memory is disclosed. The processor is configured to read a set of instructions to receive a plurality of data records. Each record in the plurality of records includes a set of features. The processor is further configured to generate a first reduced dimension feature set by applying a linear dimension reduction process to the set of features, generate a second reduced dimension feature set by applying a non-linear dimension reduction process to the first reduced dimension feature set, cluster the set of records based on the second reduced dimension feature set, and generate a training dataset by labeling each record in the plurality of records based on a cluster associated with each record. A machine learning model is trained by applying a supervised training process based on the training dataset.

In various embodiments, a computer-implemented method is disclosed. The computer-implemented method includes a step of receiving a plurality of data records. Each record in the plurality of records includes a set of features. The computer-implemented method further includes steps of generating a first reduced dimension feature set by applying a linear dimension reduction process to the set of features, generating a second reduced dimension feature set by applying a non-linear dimension reduction process to the first reduced dimension feature set, clustering the set of records based on the second reduced dimension feature set, and generating a training dataset by labeling each record in the plurality of records based on a cluster associated with each record. A machine learning model is trained by applying a supervised training process based on the training dataset.

In various embodiments, a non-transitory computer readable medium having instructions stored thereon is disclosed. The instructions, when executed by at least one processor, cause at least one device to perform operations including receiving a plurality of data records. Each record in the plurality of records includes a set of features. The instructions further cause the device to perform operations including generating a first reduced dimension feature set by applying a linear dimension reduction process to the set of features, generating a second reduced dimension feature set by applying a non-linear dimension reduction process to the first reduced dimension feature set, clustering the set of records based on the second reduced dimension feature set, and generating a training dataset by labeling each record in the plurality of records based on a cluster associated with each record. A machine learning model is trained by applying a supervised training process based on the training dataset.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide training data generation using single type, semi-supervised learning, in accordance with some embodiments;

FIG. 2 illustrates a computer system configured to implement one or more processes, in accordance with some embodiments;

FIG. 3 is a flowchart illustrating a data generation and model training method, in accordance with some embodiments;

FIG. 4 is a process flow illustrating various steps of the data generation and model training method of FIG. 3, in accordance with some embodiments;

FIG. 5 is a flowchart illustrating a training method for generating a trained machine learning model, in accordance with some embodiments;

FIG. 6 is a process flow illustrating various steps of the training method of FIG. 5, in accordance with some embodiments;

FIG. 7 illustrates an artificial neural network, in accordance with some embodiments; and

FIG. 8 illustrates a tree-based network, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for single data type, semi-supervised learning. In various embodiments, a densely labeled training dataset is generated from a set of sparsely labeled data having a limited number of labels corresponding to a first class. The training dataset is generated by applying a single class, semi-supervised process. The system receives a set of records including N records. The set of records is sparsely labeled with respect to at least a first class, e.g., a subset K of the N records are labeled as a first class, where K is substantially less than N. The set of records may include records having additional class labels, e.g., records labeled as a second class, a third class, etc., and/or includes unlabeled records. A linear dimension reduction process is applied to the set of records to generate a first reduced dimension feature set. A non-linear dimension reduction process is applied to the first reduced dimension feature set to generate a second reduced dimension feature set. Density clustering is applied based on the second reduced dimension feature set to cluster the set of records. A purity score is generated for each cluster and one of two labels is applied to each record in a cluster based on the purity score of the corresponding cluster. In some embodiments, a hyperparameter optimization process based on the determined purity score is applied to iteratively refine the non-linear dimension reduction process.

The labeled set of records includes a densely labeled training set with respect to at least the first class. The densely labeled training set may be utilized by a machine learning training process, such as a supervised machine learning process and/or rules learning ensemble model, to generate an interpretable detection (e.g., labeling) model configured to detect (e.g., label) data records of the first class. In some embodiments, the data records correspond to transaction and/or interaction records, the first class corresponds to a first fraud pattern, and the detection model comprises a fraud detection model configured to detect the first fraud pattern.

In some embodiments, systems, and methods utilizing single class, semi-supervised processes disclosed herein are configured to generate training datasets suitable for generation of one or more trained models. The generated training dataset may be used to generate trained models using any suitable training process, such as a supervised training process. In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

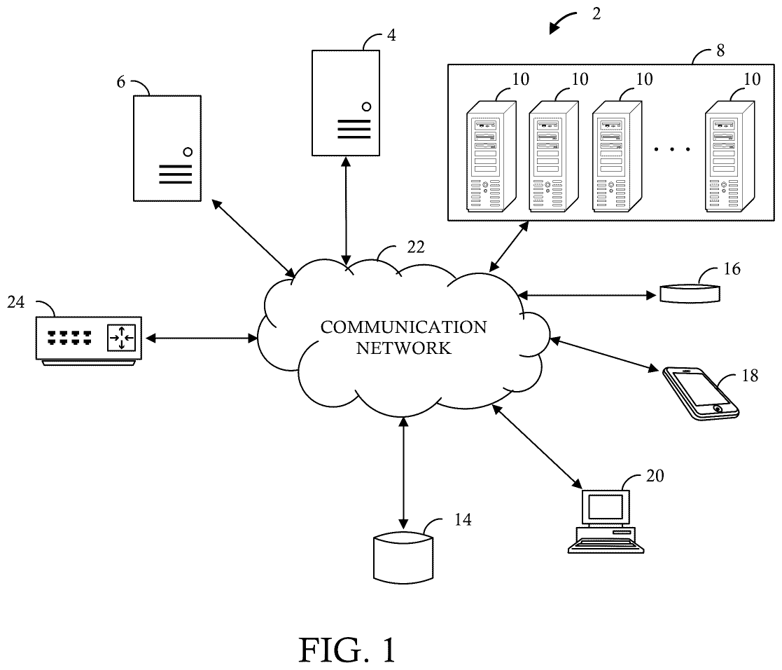

FIG. 1 illustrates a network environment 2 configured to provide training data generation using single type, semi-supervised learning, in accordance with some embodiments. The network environment 2 includes a plurality of devices or systems configured to communicate over one or more network channels, illustrated as a network cloud 22. For example, in various embodiments, the network environment 2 may include, but is not limited to, a machine learning (ML) training computing device 4, a web server 6, a cloud-based engine 8 including one or more processing devices 10, workstation(s) 12, a database 14, and/or one or more user computing devices 16, 18, 20 operatively coupled over the network 22. The ML training computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the ML training computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the ML training computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the ML training computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the ML training computing device 4, the web server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the ML training computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as a machine learning website, hosted by the web server 6. The website may also allow the user to interact with one or more of interface elements to perform specific operations, such as generating a machine learning model and/or a machine learning training dataset.

In some embodiments, the ML training computing device 4 may execute one or more models, processes, or algorithms, such as a machine learning model, deep learning model, statistical model, etc., to generate training dataset for use in additional model training. The ML training computing device 4 is further operable to communicate with the database 14 over the communication network 22. For example, the ML training computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the ML training computing device 4, in some embodiments, the database 14 may be a local storage device, such as a hard drive, a non-volatile memory, or a USB stick. The ML training computing device 4 may store interaction data received from the web server 6 in the database 14.

In some embodiments, the ML training computing device 4 generates training data for a plurality of models (e.g., machine learning models, deep learning models, statistical models, algorithms, etc.) utilizing a single type, semi-supervised learning process. The ML training computing device 4 and/or one or more of the processing devices 10 may train one or more models based on corresponding training data. The ML training computing device 4 may store the models in a database, such as in the database 14 (e.g., a cloud storage database).

The models, when executed by the ML training computing device 4, allow the ML training computing device 4 to generate a densely-labeled training dataset from a sparsely labeled dataset. In some embodiments, the ML training computing device 4 assigns the models or algorithms (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units.

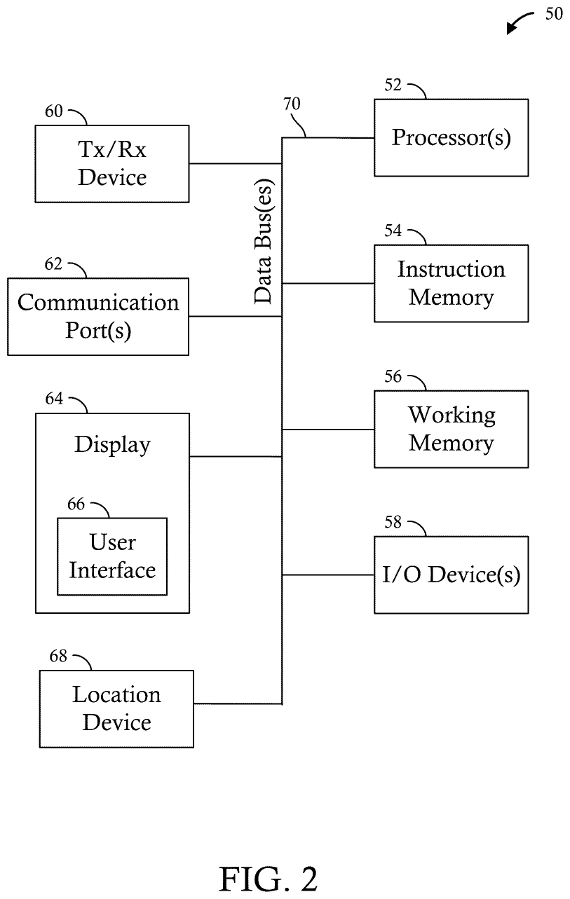

FIG. 2 illustrates a block diagram of a computing device 50, in accordance with some embodiments. In some embodiments, each of the ML training computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating training datasets using single type, semi-supervised learning, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with generated training datasets. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

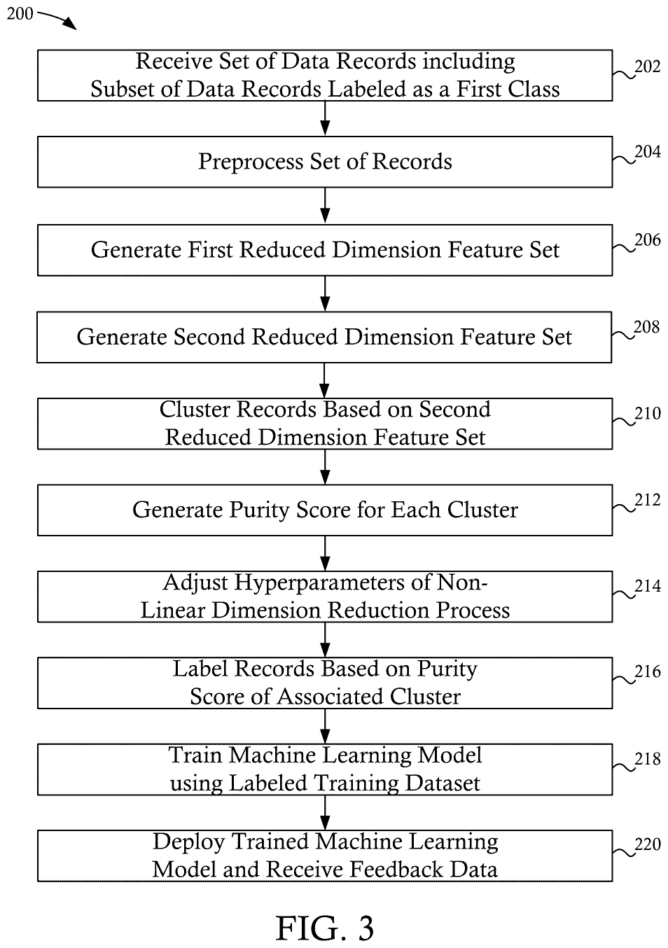

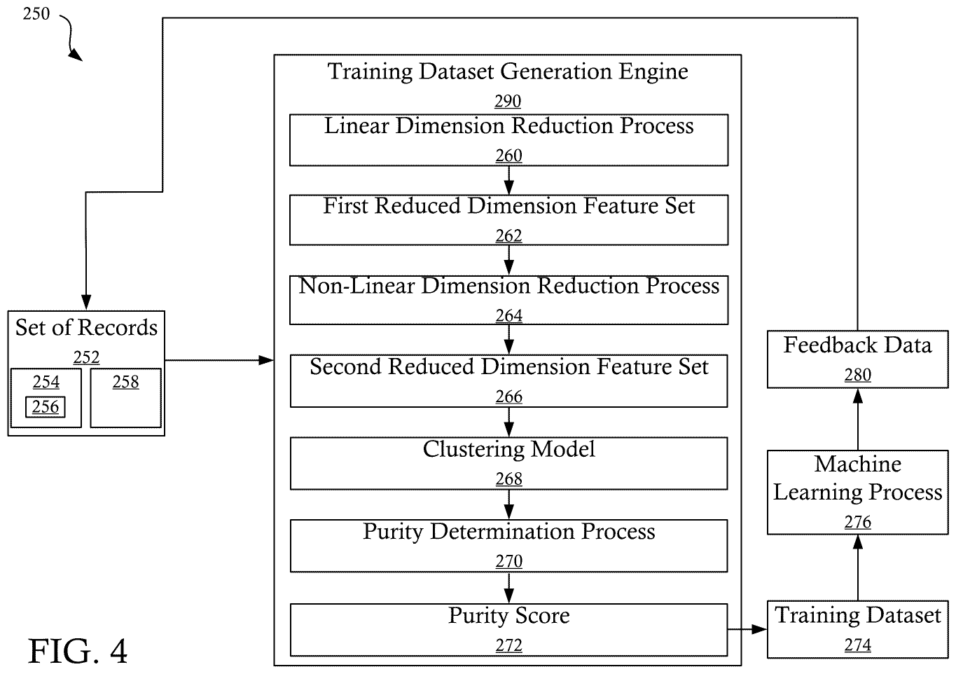

FIG. 3 is a flowchart illustrating a data generation and model training method 200, in accordance with some embodiments. FIG. 4 is a process flow 250 illustrating various steps of the data generation and model training method 200, in accordance with some embodiments. At step 202, a set of data records 252 is received. The set of data records 252 includes a set of M electronic data records related to one or more domains. In some embodiments, one or more references, such as one or more database locations, database references, web locations, etc., to a location storing the set of data records 252 is received. The set of data records 252 may be received by any suitable system, module, engine, process, etc., such as, for example, a training dataset generation engine 290.

In some embodiments, the set of data records 252 includes a set of N records. Each record 254 includes a set of variables 256. In some embodiments, the set of variables 256 includes M variables (e.g., M dimensions), where M is substantially larger than a predetermined value. For example, in some embodiments, M is substantially greater than fifty (e.g., M>>50). In some embodiments, the set of variables includes about one thousand variables. As discussed in greater detail below, the predetermined value may be related to the number of variables (e.g., dimensions) in a first reduced dimension feature set, as discussed in greater detail below. Although specific embodiments are discussed herein, it will be appreciated that the disclosed systems and methods are applicable to any set of records having a substantially large set of variables.

The set of data records 252 includes a subset of labeled records 258 labeled as a first class. The subset of labeled records 258 may include a set of K records, where K is substantially less than N (e.g., K<<N). For example, in some embodiments, N is equal to about one million and K is equal to about five hundred. The remaining records in the set of data records 252 (e.g., the records 254 not included in the subset of labeled records 258) may include records labeled as additional classes, e.g., a second class, a third class, and/or may include unlabeled records. Although specific examples are provided herein, it will be appreciated that the disclosed systems and methods are applicable to any set of records where a set of records labeled as a first class (e.g., the set of K records) is substantially less than the total number of records (e.g., the set of N records).

In some embodiments, the set of data records 252 includes a set of records related to operations that may be fraudulent. For example, in some embodiments, the set of data records 252 may include transaction records and/or interaction records including potentially fraudulent transactions and/or interactions. The set of data records 252 may include records 254 representative of and/or embodying different types of fraudulent transactions and/or interactions, with each type of fraud representing a different fraud pattern (or fraud M.O.). The subset of labeled records 258 may include records labeled as a first class of fraud corresponding to a first fraud pattern. The remainder of the set of data records 252 may include records labeled as one or more additional classes of fraud (e.g., a second class corresponding to a second fraud pattern, a third class corresponding to other fraudulent transactions, etc.) and/or unlabeled records. As one non-limiting example, in some embodiments, the set of data records 252 includes about one million records 254 each including about one thousand variables, a subset of labeled records 258 include about 500 records labeled as a first class, and a remainder of the records 254 labeled as additional classes of fraud and/or unlabeled.

At step 204, the set of records 252 is preprocessed. For example, the set of records 252 may be augmented by imputing or estimating missing values of one or more features (e.g., one or more dimensions), by applying outlier detection to remove data likely to skew training, by removing features, by normalizing the records, by converting categorical variables using one or more processes (e.g., one hot encoding, target encoding, etc.) and/or otherwise preprocessing the set of records 252. Although specific embodiments, are discussed herein, it will be appreciated that any suitable preprocessing steps may be applied to the set of records 252.

At step 206, a first reduced dimension feature set 262 is generated for each record 254 by applying a linear dimension reduction process 260 to the set of variables 256 associated with each record 254. The first reduced dimension feature set 262 includes a set of O dimensions, where O is substantially less than M. The linear dimension reduction process 260 is configured to generate a first reduced dimension feature set 262 that maintains the structure and relationships of the set of variables 256, e.g., the set of O dimensions has the same (or substantially similar) topology as the set of M dimensions. The linear dimension reduction process 260 may include a feature projection process configured to project the original M dimensions to the set of O dimensions. In some embodiments, the linear dimension reduction process 260 includes a principal component analysis (PCA) process. A PCA process includes a projection of a set of columns (e.g. the original M dimensions) into a reduced set of columns (e.g. the set of O dimensions).

In some embodiments, the linear dimension reduction process 260 provides a reduction of one or more orders of magnitude such that O is substantially smaller than M. For example, in some embodiments, the set of variables 256 includes about one thousand variables (e.g., M≅1000) and the first reduced dimension feature set 262 includes fifty dimensions (e.g., O=50), a reduction of about two orders of magnitude. Although exemplary embodiments are discussed herein, it will be appreciated that the linear dimension reduction process 260 may be configured to generate a first reduced dimension feature set 262 having any suitable number of dimensions that is substantial less than the number of dimension in the set of variables 256 while maintaining the topology of the set of variables 256.

At step 208, a second reduced dimension feature set 266 is generated for each record 254 by applying a non-linear dimension reduction process 264 to the first reduced dimension feature set 262 associated with each record 254. The second reduced dimension feature set 266 includes a set of P dimensions, where P is substantially smaller than O. The non-linear dimension reduction process 264 is configured to generate a second reduced dimension feature set 266 that substantially maintains the structure and relationships of the set of variables 256, e.g., the set of P dimensions has a similar topology as the set of O dimensions. The non-linear dimension reduction process 264 may apply a fuzzy topological structure to generate the second reduced dimension feature set 266. In some embodiments, the non-linear dimension reduction process 264 includes a uniform manifold approximation and reduction (UMAP) process. A UMAP process generates an embedding by searching for a low dimensional projection of the set of O dimensions (or a subset thereof) that has a closest possible equivalent fuzzy topological structure. Each embedding generated by the UMAP process is one dimension of the second reduced dimension feature set 266.

In some embodiments, the non-linear dimension reduction process 264 provides a reduction of one or more orders of magnitude such that P is substantially smaller than O. For example, in some embodiments, the first reduced dimension feature set includes fifty dimensions (e.g., O=50) and the second reduced dimension feature set 266 includes three dimensions (e.g., P=3), a reduction of more than one order of magnitude. Although exemplary embodiments are discussed herein, it will be appreciated that the non-linear dimension reduction process 264 may be configured to generate a second reduced dimension feature set 266 having any suitable number of dimensions that is substantial less than the number of dimension in the first reduced dimension feature set 262 while maintaining a similar topology of the first reduced dimension feature set 262.

At step 210, the set of records 252 is clustered based on the second reduced dimension feature set 266. In some embodiments, the set of records 252 is clustered by a clustering model 268. The clustering model 268 may include any suitable clustering process and/or framework, such as, for example, a dense clustering framework. For example, in some embodiments, the clustering model 268 includes a hierarchical density-based spatial clustering with application (HDBSCAN) framework. HDBSCAN is configured to identify clusters of varying densities based on robust parameter selection.

The clustering model 268 is configured to receive the second reduced dimension feature set 266 as a set of inputs and cluster the set of records based on the limited number of dimensions in the second reduced dimension feature set 266. To continue the example from above, in some embodiments, the clustering model 268 is configured to receive a second reduced dimension feature set 266 including three dimensions and generate a set of variable density clusters based on the received three dimensions. Although specific embodiments are discussed herein, it will be appreciated that the clustering model can be configured to receive any suitable number of variables included in the second reduced dimension feature set 266.

At step 212, a purity score 272 is generated by a purity determination process 270 for each cluster generated by the clustering model 268. Purity score 272 is representative of the ratio of known records of the first class (e.g., records included in the subset of labeled records 258) to unknown and/or alternatively labeled records in a cluster. In some embodiments, a purity score 272 may be generated according to an equation:

$$Purity = \frac{{\sum }_{i}^{c} ( ( \frac{{A}_{i}}{{B}_{i}} > 2 r ) + ( \frac{{A}_{i}}{{B}_{i}} < 0.5 r ) ) * w ( {B}_{i} )}{{\sum }_{i}^{c} w ( {B}_{i} )}$$

where c is the number of clusters generated by the clustering model 268, Aᵢ is the number of labeled records in the i^{th} cluster (e.g., the number of records in the i^{th} cluster included in the subset of labeled records 258), Bᵢ is the size of the i^{th} cluster (e.g., the total number of records in the i^{th} cluster), w(x) is a weight adjustment function, and r is a label ratio baseline. The weight adjustment function w(x) may be configured to reduce the total number of clusters generated by the clustering model 268.

At optional step 214, the purity score 272 of one or more clusters may be utilized to adjust one or more hyperparameters of the non-linear dimension reduction process 264. The purity score 272 may be generated by a purity score determination process 270. For example, in some embodiments, the non-linear dimension reduction process 264 may be generated and/or optimized by an iterative training process configured to adjust one or more hyperparameters based on a cost function implemented during the iterative training process. In some embodiments, a purity score 272 for at least one cluster is provided as an input to the cost function of a non-linear dimension reduction training process and is utilized to adjust hyperparameters of a trained non-linear dimension reduction process 264.

At step 216, a label is applied to each record 254 in a cluster based on a purity score associated with the cluster. For example, in some embodiments, when a purity score of a cluster is greater than (or equal to) a predetermined threshold value, each record 254 in the cluster is labeled as being a first class of record. Similarly, when a purity score of a cluster is less than (or equal to) a predetermined threshold value, each record 254 in the cluster is labeled as not the first class, e.g., labeled as a second class, labelled as a null class, labeled as a “not first class” class, etc. Propagation of labels based on the purity score generates a training dataset 274 including the set of records 252 with each record 254 labeled with one of two possible labels, e.g., the first class or not the first class.

At step 218, a machine learning process 276 is executed based on the training dataset 274. The machine learning process 276 is configured to generate a trained machine learning model 74, such as a trained detection model, configured to detect records of the first class. In some embodiments, the machine learning process 276 includes a supervised machine learning process, such as advanced rule learning and/or any other suitable supervised machine learning process. In some embodiments, the subset of labeled records 258 may be used as a verification and/or testing dataset for a trained machine learning model.

At optional step 220, the trained machine learning model is deployed and feedback data 280 including at least one additional data record is received. The additional data record includes one of the labels assigned by the trained machine learning model. In some embodiments, the additional data record(s) are incorporated into a set of records 252 used for subsequent generation of a training dataset 274 and/or iterative training of updated trained machine learning models. The feedback data 280 may additional include re-labeled data records, unlabeled data records, and/or any other suitable additional data records. As illustrated in FIG. 3, the data generation and training method 200 may return to step 202 after receiving the feedback data 280 and generate a new training dataset 274 and/or a new trained machine learning model as described above. The updated training datasets and/or machine learning models may be generated at predetermined intervals, such as, for example, once a week, once a month, twice a month, every 15 days, etc.

The disclosed systems and methods applies a semi-supervised machine learning approach utilizing on a limited number of records labeled as a single class. The disclosed training data generation method allows for a larger variable space to be utilized for class detection as compared to manually labelled training datasets, which are limited to smaller sets and fewer variables. The disclosed semi-supervised machine learning approach allows training of detection models that rely on data model evidence (e.g., training datasets), instead of requiring manual labeling and application of limited or potentially non-existent expertise. The disclosed systems and methods allow detection models to be generated and applied in new fields or domains having limited or emerging expertise. The generated training datasets provided flexibility for generation of trained detection models and the applied detection (e.g., tagging) logic, providing trained models that are adaptive and adjustable.

In some embodiments, the iterative adjustment of the non-linear dimension reduction process 264 allows the disclosed semi-supervised machine learning approach to react to concept drift and data drift over time by continuously updating and/or refining the applied dimension reduction processes. In addition, the disclosed semi-supervised machine learning approach requires only a single labeled class, obviating the need to label all potential classes used by existing semi-supervised learning approaches.

Generation of reduced dimension feature sets, clustering of records based on reduced dimension feature sets, propagation of record labels, and generation of trained models based on generated training datasets is only possible with the aid of computer-assisted machine-learning algorithms and techniques, such as the disclosed semi-supervised machine learning approach. In some embodiments, machine learning processes including linear and/or non-linear dimension reduction processes and/or clustering models are used to perform operations that cannot practically be performed by a human, either mentally or with assistance, such as reductions in large numbers of dimensions and/or clustering of records. It will be appreciated that a variety of machine learning techniques can be used alone or in combination to generate linear dimension reduction processes, non-linear dimension reduction processes, clustering models, and/or trained detection models.

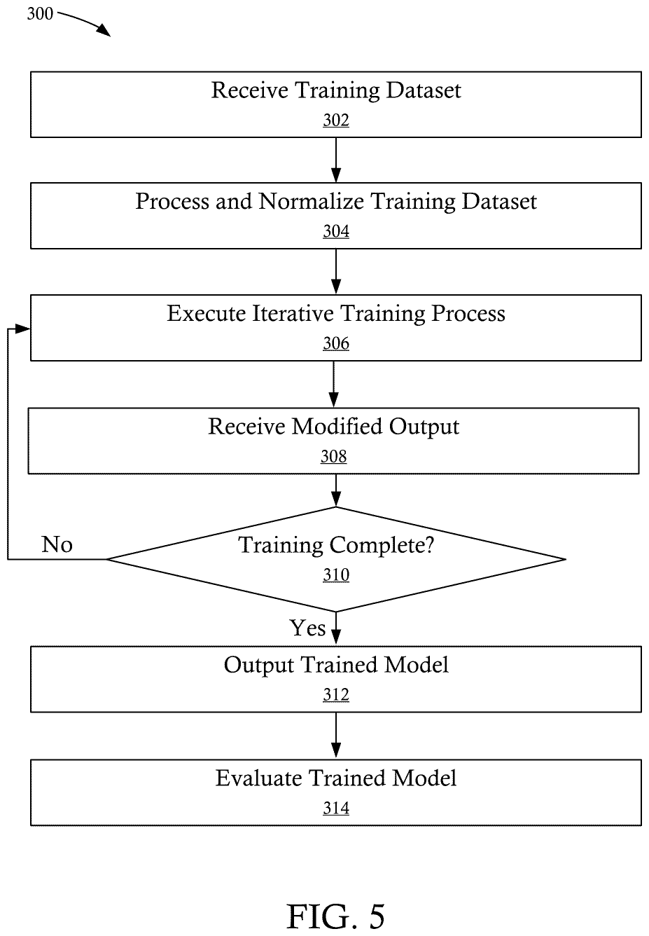

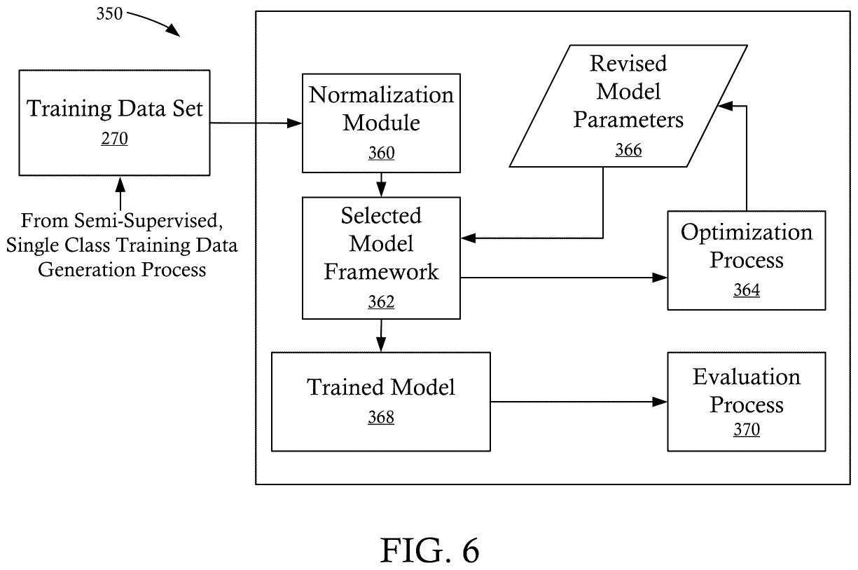

In some embodiments, one or more trained models, such as one or more trained detection models, can be generated using an iterative training process based on a training dataset 274 generated using the disclosed semi-supervised machine learning approach. FIG. 5 illustrates a method 300 for generating a trained model, such as a trained detection model, in accordance with some embodiments. FIG. 6 is a process flow 350 illustrating various steps of the method 300 of generating a trained model, in accordance with some embodiments. At step 302, a training dataset 274 is received by a system. The training dataset 274 includes labeled data generated by a dataset generation process, such as, for example, the data generation method 200 discussed above with respect to FIGS. 3-4. The training dataset 274 includes a set of records 254 each labeled with one of two labels, e.g., a first class or not a first class.

At optional step 304, the received training dataset 274 is processed and/or normalized by a normalization module 360. For example, in some embodiments, the training dataset 274 can be augmented by imputing or estimating missing values of one or more features associated with a detection model. In some embodiments, processing of the received training dataset 274 includes outlier detection configured to remove data likely to skew training of a detection model. In some embodiments, optional step 304 is omitted based on the preprocessing applied at step 204 of the training data generation method 200.

At step 306, an iterative training process is executed to train a selected model framework 362. The selected model framework 362 can include an untrained (e.g., base) machine learning model, such as an untrained labeling framework, an untrained clustering framework, etc. and/or a partially or previously trained model (e.g., a prior version of a trained model). In some embodiments, the untrained labeling framework includes a supervised training framework. The training process is configured to iteratively adjust parameters (e.g., hyperparameters) of the selected model framework 362 to minimize a cost value (e.g., an output of a cost function) for the selected model framework 362. In some embodiments, the cost value is related to identification of records of the first class.

The training process is an iterative process that generates set of revised model parameters 366 during each iteration. The set of revised model parameters 366 can be generated by applying an optimization process 364 to the cost function of the selected model framework 362. The optimization process 364 can be configured to reduce the cost value (e.g., reduce the output of the cost function) at each step by adjusting one or more parameters during each iteration of the training process.

After each iteration of the training process, at step 308, a determination is made whether the training process is complete. The determination at step 308 can be based on any suitable parameters. For example, in some embodiments, a training process can complete after a predetermined number of iterations. As another example, in some embodiments, a training process can complete when it is determined that the cost function of the selected model framework 362 has reached a minimum, such as a local minimum and/or a global minimum.

At step 310, a trained model 368, such as a trained detection model, is output and provided for use in a detection process, such as a fraud detection process. At optional step 312, a trained model 368 can be evaluated by an evaluation process 370. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. In some embodiments, the trained model 368 is evaluated based on the original subset of labeled records 258 included in the training dataset 274. Although specific embodiments are discussed herein, it will be appreciated that any suitable set of evaluation metrics can be used to evaluate a trained model.

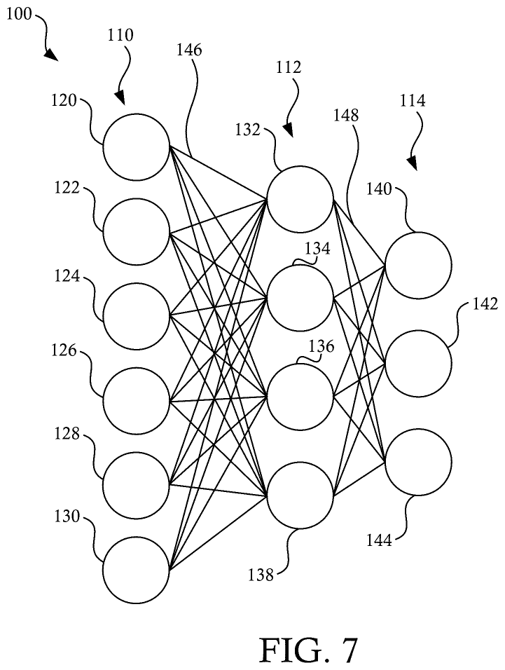

FIG. 7 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arc tangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

w′_{i,j}⁽ⁿ⁾=w_{i,j}⁽ⁿ⁾−γ·δⱼ⁽ⁿ⁾·xᵢ⁽ⁿ⁾

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f is the first derivative of the activation function, and yⱼ⁽ⁿ⁺¹⁾ is the comparison training value for the j-th node of the output layer 114.

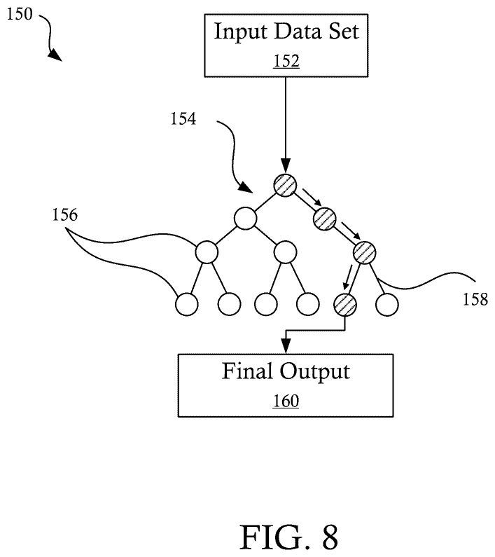

FIG. 8 illustrates a tree-based network 150, in accordance with some embodiments. A tree-based network 150 can include a rules-based network and/or a neural network (e.g., a random forest neural network). For example, in some embodiments, the tree-based network 150 may include, but is not limited to, a decision tree network, a C5.0 decision tree network, a classification and regression tree (CART) network, a logistic regression-based tree, etc. The tree-based network 150 may be configured to provide interpretable results and/or may utilize “black box” networks. For example, in some embodiments, a network configured to provide an interpretable tree is provided to increase confidence and credibility of classification results with respect to one or more use cases. As another example, in some embodiments, a “black box” algorithm, such as a deep learning network, may be utilized to provide higher accuracy while sacrificing interpretability of the results. It will be appreciated that the tree-based network 150 can include any suitable network architecture configured to provide a desired balance between interpretability and accuracy based on a corresponding use case.

The tree-based network 150 includes at least one trained decision tree 154 including a set of nodes 156 (also referred to as “leaves”) and a set of edges 158 (also referred to as “branches”). In operation, an input data set 152 including one or more features or attributes is received. A subset of the input data set 152 is provided to the trained decision tree 154. The subset may include a portion of and/or all of the features or attributes included in the input data set 152. The trained decision tree 154 is traversed based on the subset of the input data set 152 and to select a final leaf node. The final leaf node is provided as a final output 160 from the tree-based network 150.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a plurality of data records, wherein each record in the plurality of records includes a set of features;
generate a first reduced dimension feature set by applying a linear dimension reduction process to the set of features;
generate a second reduced dimension feature set by applying a non-linear dimension reduction process to the first reduced dimension feature set;
cluster the set of records based on the second reduced dimension feature set;
generate a training dataset by labeling each record in the plurality of records based on a cluster associated with each record; and
train a machine learning model by applying a supervised training process based on the training dataset.

2. The system of claim 1, wherein the linear dimension reduction process comprises a feature projection process.

3. The system of claim 1, wherein the non-linear dimension reduction process comprises applying a fuzzy topological structure to generate the second reduced dimension feature set.

4. The system of claim 1, wherein the set of features includes M dimensions and the first reduced dimension feature set includes O dimensions, and wherein the linear dimension reduction process is configured to project the M dimensions of the set of features to the O dimensions of the first reduced dimensions feature set.

5. The system of claim 4, wherein the second reduced dimension featured set includes P dimensions, and wherein P is less than O, and wherein the second reduced dimension featured set has a similar topology as the first reduced dimension featured set.

6. The system of claim 1, wherein the processor is configured to determine a purity score for each cluster of the set of records.

7. The system of claim 6, wherein the processor is configured to:
revise at least one hyperparameter of the non-linear dimension reduction process based on the purity score of at least one cluster; and
generate an updated second reduced dimension feature set by applying the non-linear dimension reduction process including the revised at least one hyperparameter, wherein the updated second reduced dimension feature set is utilized to generate the training dataset.

8. The system of claim 6, wherein the processor is configured to label each record in a cluster as a first class record when the purity score exceeds a predetermined threshold.

9. The system of claim 1, wherein clusters of the set of records are generated by a dense clustering process.

10. A computer-implemented method, comprising:
receiving a plurality of data records, wherein each record in the plurality of records includes a set of features;
generating a first reduced dimension feature set by applying a linear dimension reduction process to the set of features;
generating a second reduced dimension feature set by applying a non-linear dimension reduction process to the first reduced dimension feature set;
clustering the set of records based on the second reduced dimension feature set;
generating a training dataset by labeling each record in the plurality of records based on a cluster associated with each record; and
training a machine learning model by applying a supervised training process based on the training dataset.

11. The computer-implemented method of claim 10, wherein the linear dimension reduction process comprises a feature projection process.

12. The computer-implemented method of claim 10, wherein the non-linear dimension reduction process comprises applying a fuzzy topological structure to generate the second reduced dimension feature set.

13. The computer-implemented method of claim 10, wherein the set of features includes M dimensions and the first reduced dimension feature set includes O dimensions, and wherein the linear dimension reduction process is configured to project the M dimensions of the set of features to the O dimensions of the first reduced dimensions feature set.

14. The computer-implemented method of claim 13, wherein the second reduced dimension featured set includes P dimensions, and wherein P is less than O, and wherein the second reduced dimension featured set has a similar topology as the first reduced dimension featured set.

15. The computer-implemented method of claim 10, comprising determining a purity score for each cluster of the set of records.

16. The computer-implemented method of claim 15, comprising:
revising at least one hyperparameter of the non-linear dimension reduction process based on the purity score of at least one cluster; and
generating an updated second reduced dimension feature set by applying the non-linear dimension reduction process including the revised at least one hyperparameter, wherein the updated second reduced dimension feature set is utilized to generate the training dataset.

17. The computer-implemented method of claim 15, comprising labeling each record in a cluster as a first class record when the purity score exceeds a predetermined threshold.

18. The computer-implemented method of claim 10, wherein clusters of the set of records are generated by a dense clustering process.

19. A non-transitory computer readable medium having instructions stored thereon, wherein the instructions, when executed by at least one processor, cause at least one device to perform operations comprising:
receiving a plurality of data records, wherein each record in the plurality of records includes a set of features, and wherein the plurality of data records includes a subset of data records having a first set of dimensions;
generating a first reduced dimension feature set by applying a linear dimension reduction process to the set of features, wherein the first reduced dimension feature set has a second set of dimensions less than the first set of dimensions;
generating a second reduced dimension feature set by applying a non-linear dimension reduction process to the first reduced dimension feature set, wherein the second reduced dimension feature set has a third set of dimensions less than the second set of dimensions, and wherein the second set of dimensions and the third set of dimensions have a similar topology;
clustering the set of records based on the second reduced dimension feature set;
generating a training dataset by labeling each record in the plurality of records based on a cluster associated with each record; and
training a machine learning model by applying a supervised training process based on the training dataset.

20. The non-transitory computer readable medium of claim 19, wherein clusters of the set of records are generated by a dense clustering process.
